(19) United States
(12) Patent Application Publication
(10) Pub. No.: US 2007/0279788 A1
(43) Pub. Date: Dec. 6, 2007

(54) METHOD AND APPARATUS TO PERFORM DEFECT SCANNING

(75) Inventors: James W. Andersen, San Jose, CA (US); Craig Tomita, Pleasanton, CA (US)

Correspondence Address: SCHWEGMAN, LUNDBERG & WOESSNER, P.A., P.O. BOX 2938, MINNEAPOLIS, MN, 55402, US

(73) Assignee: Toshiba America Information Systems, Inc.

(21) Appl. No.: 11/421,446

(22) Filed: May 31, 2006

(51) Int. Cl. G11B 5/09

(52) U.S. Cl. 360/53

(57) ABSTRACT

A method of determining defects on a media of an information storage device includes reading information representing data from a magnetized portion of the media, processing the read signal with discrete time signal processing, and detecting a phase shift in the read signal over a selected threshold. The method also includes sending an indication of a defect in the media in response to detecting the phase shift over the selected threshold, determining the location of the media of the defect, and storing the location of the defect in memory.

### BACKGROUND

A disk drive is an information storage device. A disk drive includes one or more disks clamped to a rotating spindle, and at least one head for reading information representing data from and/or writing data to the surfaces of each disk. More specifically, storing data includes writing information representing data to portions of tracks on a disk so that it can be subsequently read and retrieved. Disk drives associated with a computing system generally execute write commands from a host computer. By the time a write command from a host computer passes through a read/write channel of the disk drive, the write command includes specific information including the location on the disk where the specific information will be written.

The disks of a disk drive include a magnetic layer or several magnetic layers formed on a non-magnetic disk substrate made of glass, aluminum or the like. The magnetic layer is magnetized by a transducing head. In some disk drives, the transducing head has a write head for writing information representing data to the disk and a separate read head for reading information from the disk. Writing information to the disk includes magnetizing the magnetic layer or layers of the disk using the write element of the transducer. Reading information from the magnetic layer or layers includes sensing the magnetized portions of the disk to reproduce the information representing data. Disk drives include a channel. The channel includes the components needed to handle writing information representing data to a disk and reading information representing data from the disk.

In general, it is almost impossible to fabricate a perfect defect-free disk in view of its fabrication process, and the need to produce a disks having a high product yield and a low production cost. Thus, disk manufacturers and hard disk drive manufacturers allow disks to be defective to a certain extent. To prevent defects from adversely effecting the ability of the disk drive to store and retrieve information representative of data, the manufacturing process includes a process whereby defective areas on the disk are detected and then mapped. These defective areas are avoided when executing future write commands. In this way, known defective areas are avoided so writing occurs only to the magnetic layer or layers of the disk that are not defective. In other words, defects are detected beforehand so the defective portion can be avoided when the disk drive is used. As a result, the consumer experiences a much more reliable disk drive.

During manufacture, a disk drive undergoes a burn-in process where the disk drive is run for a selected amount of time. A disk drive has many electronic components. It is known that in many instances, a high percentage of electronics, if prone to failure, will fail within the first several hours of operation. If failure occurs during burn-in, the disk drive is rejected and may be sent for rework or merely scrapped. The burn-in test, in one example, is implemented on a rack in a burn-in room and consumes generally 8-16 hours. The burn-in process is generally longer than any other step in the hard disk drive fabrication process.

A defect detecting test may be performed during the burn-in process. Defect detecting includes a self-test wherein a microprocessor that controls the operations of the hard disk drive performs a write/read test on the entire areas of a disk surface, while applying a stress on a read/write channel. The stresses induced include generally stress some parameter associated with read/write channel. These stresses tend to magnify defects or induce defects that might not otherwise be detected. During the write/read test, a portion of the disk that includes a defect resulting in a write/read error is detected and the address of the defect is written to a defect list.

A constant trend related to hard disk drives is toward increasing the recording density of a disk to increase the storage capacity of the disk. As a result, micro defects, which may have caused negligibly small and correctable errors in lower recording density drives, now generate errors that may not be corrected. The challenge is to formulate a series of tests to determine defects which stress the drive to produce defects that need to be mapped, and which does not overstress the system and trigger an over abundance of “defects” that may never show up over the life of the disk drive.

Another trend is toward perpendicular or vertical recording. Another challenge includes formulating tests which can also be used to detect defects in disk drives that use perpendicular or vertical recording.

### BRIEF DESCRIPTION OF THE DRAWINGS

The invention is pointed out with particularity in the appended claims. However, a more complete understanding of the present invention may be derived by referring to the detailed description when considered in connection with the figures, wherein like reference numbers refer to similar items throughout the figures and:

FIG. 1 is an exploded view of a disk drive that uses example embodiments described herein.

FIG. 2 is a schematic diagram of a disk drive and includes various electrical portions of the disk drive, according to an example embodiment.

FIG. 3 is a schematic diagram showing portions of the read/write path of FIG. 2, according to an example embodiment.

FIG. 4 is a flow diagram of a method for selecting a write current for a magnetic medium in a disk drive, according to an example embodiment.

FIG. 5A is a first portion of a flow diagram of a method for selecting a write current for a magnetic medium, according to an example embodiment.

FIG. 5B is a second portion of a flow diagram of a method for selecting a write current for a magnetic medium, according to an example embodiment.

FIG. 6 is a graph for selecting an optimum write current level for a magnetic medium in a disk drive, according to an example embodiment.

FIG. 7 is a flow diagram of yet another method for selecting a write current for a magnetic media, according to an example embodiment.

FIG. 8 is a flow diagram of a method detailing one example embodiment of determining defects on a media by stressing the disk drive using the write current, according to an example embodiment.

FIG. 9 is a representation of 747 curve which is used in determining an optimal track width or an optimal distance between recording tracks, according to an example embodiment.

FIG. 10 is a flow diagram of a method detailing one example embodiment of determining defects on a media by stressing the disk drive by writing the tracks having less than an optimal or substantially optimal width, according to an example embodiment.

FIG. 11 is an apparatus for detecting defects, according to an example embodiment.

FIG. 12 is a flow diagram of a method detailing of determining defects on a media, according to an example embodiment.

FIG. 13 is a representation of a computing system, according to an example embodiment.

FIG. 14 is schematic of a machine-readable media, according to an example embodiment.

The description set out herein illustrates the various embodiments of the invention and such description is not intended to be construed as limiting in any manner.

### DETAILED DESCRIPTION

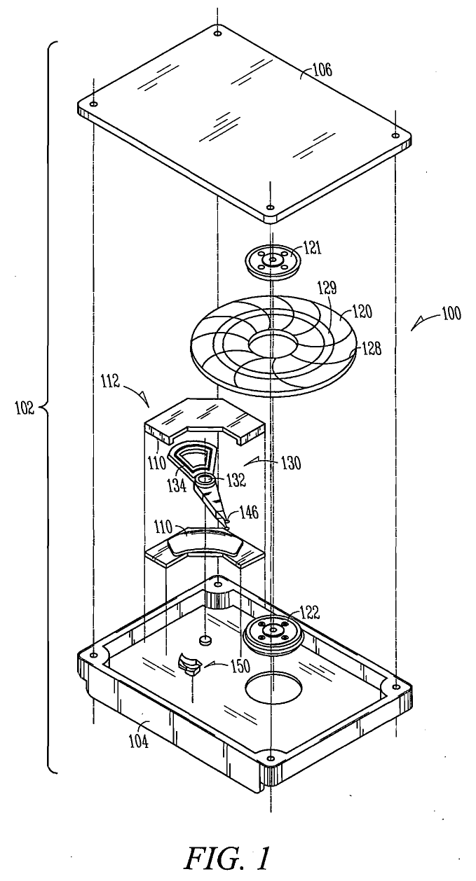

FIG. 1 is an exploded view of disk drive 100 that uses various embodiments of the present invention. The disk drive 100 includes a housing 102 including a housing base 104 and a housing cover 106. The housing base 104 illustrated is a base casting, but in other embodiments a housing base 104 can comprise separate components assembled prior to, or during assembly of the disk drive 100. A disk 120 is attached to a hub or spindle 122 that is rotated by a spindle motor. The disk 120 can be attached to the hub or spindle 122 by a clamp 121. The disk may be rotated at a constant or varying rate ranging from less than 3,600 to more than 15,000 revolutions per minute. Higher rotational speeds are contemplated in the future. The spindle motor is connected with the housing base 104. The disk 120 can be made of a light aluminum alloy, ceramic/glass or other suitable substrate, with magnetizable material deposited on one or both sides of the disk. The magnetic layer includes small domains of magnetization for storing data transferred through a transducing head 146. The transducing head 146 includes a magnetic transducer adapted to read data from and write data to the disk 120. In other embodiments, the transducing head 146 includes a separate read element and write element. For example, the separate read element can be a magneto-resistive head, also known as a MR head. It will be understood that multiple head 146 configurations can be used.

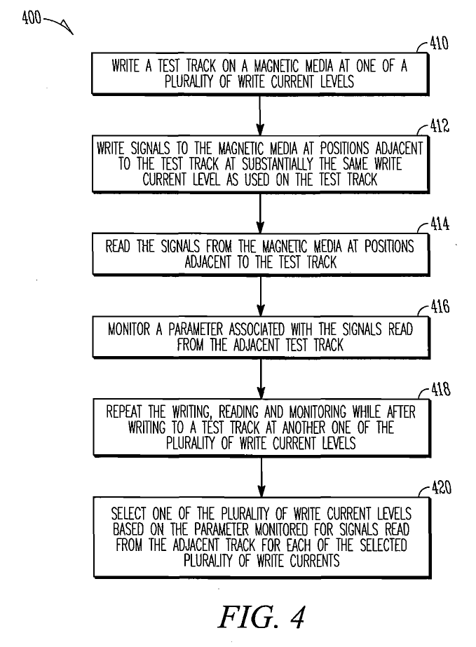

A rotary actuator 130 is pivotally mounted to the housing base 104 by a bearing 132 and sweeps an arc between an inner diameter (ID) of the disk 120 and a ramp 150 positioned near an outer diameter (OD) of the disk 120. Attached to the housing 104 are upper and lower magnet return plates 110 and at least one magnet that together form the stationary portion of a voice coil motor (VCM) 112. A voice coil 134 is mounted to the rotary actuator 130 and positioned in an air gap of the VCM 112. The rotary actuator 130 pivots about the bearing 132 when current is passed through the voice coil 134 and pivots in an opposite direction when the current is reversed, allowing for control of the position of the actuator 130 and the attached transducing head 146 with respect to the disk 120. The VCM 112 is coupled with a servo system (shown in FIG. 4) that uses positioning data read by the transducing head 146 from the disk 120 to determine the position of the head 146 over one of a plurality of tracks on the disk 120. The servo system determines an appropriate current to drive through the voice coil 134, and drives the current through the voice coil 134 using a current driver and associated circuitry (not shown in FIG. 1).

Each side of a disk 120 can have an associated head 146, and the heads 146 are collectively coupled to the rotary actuator 130 such that the heads 146 pivot in unison. The invention described herein is equally applicable to devices wherein the individual heads separately move some small distance relative to the actuator. This technology is referred to as dual-stage actuation (DSA).

One type of servo system is an embedded, servo system in which tracks on each disk surface used to store information representing data contain small segments of servo information. The servo information, in some embodiments, is stored in radial servo sectors or servo wedges 128 shown as several narrow, somewhat curved spokes substantially equally spaced around the circumference of the disk 120. It should be noted that in actuality there may be many more servo wedges than as shown in FIG. 1.

The disk 120 also includes a plurality of tracks on each disk surface. The plurality of tracks is depicted by two tracks, such as track 129 on the surface of the disk 120. The servo wedges 128 traverse the plurality of tracks, such as track 129, on the disk 120. The plurality of tracks, in some embodiments, may be arranged as a set of substantially concentric circles. Data is stored in fixed sectors along a track between the embedded servo wedges 128. The tracks on the disk 120 each include a plurality of data sectors. More specifically, a data sector is a portion of a track having a fixed block length and a fixed data storage capacity (e.g. 512 bytes of user data per data sector). The tracks toward the inside of the disk 120 are not as long as the tracks toward the periphery of the disk 110. As a result, the tracks toward the inside of the disk 120 can not hold as many data sectors as the tracks toward the periphery of the disk 120. Tracks that are capable of holding the same number of data sectors are grouped into a data zones. Since the density and data rates vary from data zone to data zone, the servo wedges 128 may interrupt and split up at least some of the data sectors. The servo wedges 128 are typically recorded with a servo writing apparatus at the factory (called a servo-writer), but may be written (or partially written) with the disk drive's 100 transducing head 146 in a self-servowriting operation.

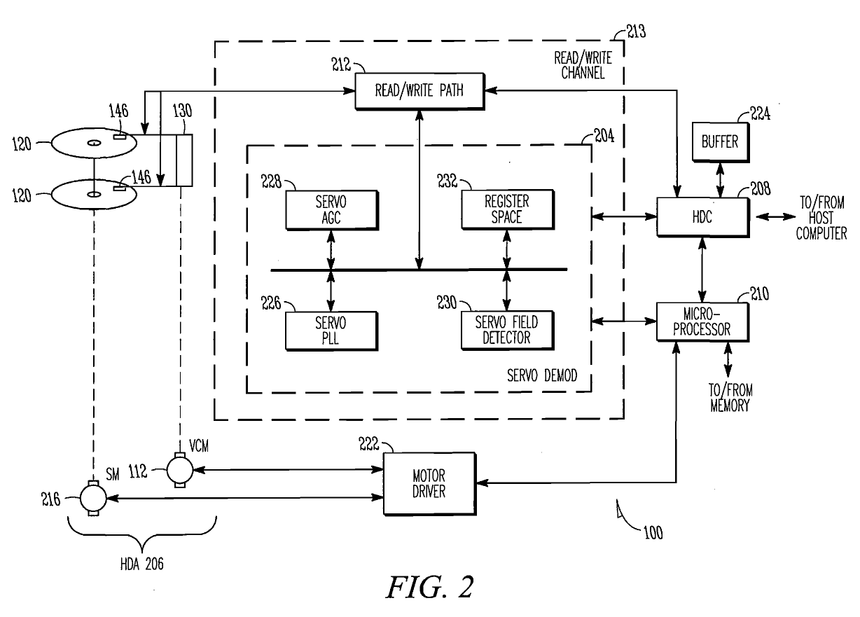

The disk drive 100 not only includes many mechanical features and a disk with a servo pattern thereon, but also includes various electronics for reading signals from the disk 120 and writing information representing data to the disk 120. FIG. 2 is a schematic diagram of a disk drive 100 that more fully details some of example electronic portions of the disk drive 100, according to an example embodiment. Referring to FIG. 2, the disk drive device 202 is shown as including a head disk assembly (HDA) 206, a hard disk controller (HDC) 208, a read/write channel 213, a microprocessor 210, a motor driver 222 and a buffer 224. The read/write channel 213 is shown as including a read/write path 212 and a servo demodulator 204. The read/write path 212, which can be used to read and write user data and servo data, may include front end circuitry useful for servo demodulation. The read/write path 212 may also be used for writing servo information in self-servowriting. It should be noted that the disk drive 100 also includes other components, which are not shown because they are not necessary to explain the example embodiments.

The HDA 206 includes one or more disks 120 upon which data and servo information can be written to, or read from, by transducers or transducing heads 146. The voice coil motor (VCM) 112 moves an actuator 130 to position the transducing heads 146 on the disks 110. The motor driver 222 drives the VCM 112 and the spindle motor (SM) 216. More specifically, the microprocessor 210, using the motor driver 222, controls the VCM 112 and the actuator 130 to accurately position the heads 146 over the tracks (described with reference to FIGS. 1-3) so that reliable reading and writing of data can be achieved. The servo fields 128, discussed above in the description of FIGS. 1-3, are used for servo control to keep the heads 146 on track and to assist with identifying proper locations on the disks 120 where data is written to or read from. When reading a servo wedge 128, the transducing heads 146 act as sensors that detect the position information in the servo wedges 128, to provide feedback for proper positioning of the transducing heads 146.

The servo demodulator 204 is shown as including a servo phase locked loop (PLL) 226, a servo automatic gain control (AGC) 228, a servo field detector 230 and register space 232. The servo PLL 226, in general, is a control loop that is used to provide frequency and phase control for the one or more timing or clock circuits (not shown in FIG. 2), within the servo demodulator 204. For example, the servo PLL 226 can provide timing signals to the read/write path 212. The servo AGC 228, which includes (or drives) a variable gain amplifier, is used to keep the output of the read/write path 212 at a substantially constant level when servo wedges 128 on one of the disks 120 are being read. The servo field detector 230 is used to detect and/or demodulate the various subfields of the servo wedges 128, including the SAM 204, the track number 206, the first phase servo burst 210, and the second phase servo burst 220. The microprocessor 210 is used to perform various servo demodulation functions (e.g., decisions, comparisons, characterization and the like), and can be thought of as being part of the servo demodulator 204. In the alternative, the servo demodulator 204 can have its own microprocessor.

One or more registers (e.g., in register space 232) can be used to store appropriate servo AGC values (e.g., gain values, filter coefficients, filter accumulation paths, etc.) for when the read/write path 212 is reading servo data, and one or more registers can be used to store appropriate values (e.g., gain values, filter coefficients, filter accumulation paths, etc.) for when the read/write path 212 is reading user data. A control signal can be used to select the appropriate registers according to the current mode of the read/write path 212. The servo AGC value(s) that are stored can be dynamically updated. For example, the stored servo AGC value(s) for use when the read/write path 212 is reading servo data can be updated each time an additional servo wedge 128 is read. In this manner, the servo AGC value(s) determined for a most recently read servo wedge 128 can be the starting servo AGC value(s) when the next servo wedge 128 is read.

The read/write path 212 includes the electronic circuits used in the process of writing and reading information to and from disks 120. The microprocessor 210 can perform servo control algorithms, and thus, may be referred to as a servo controller. Alternatively, a separate microprocessor or digital signal processor (not shown) can perform servo control functions.

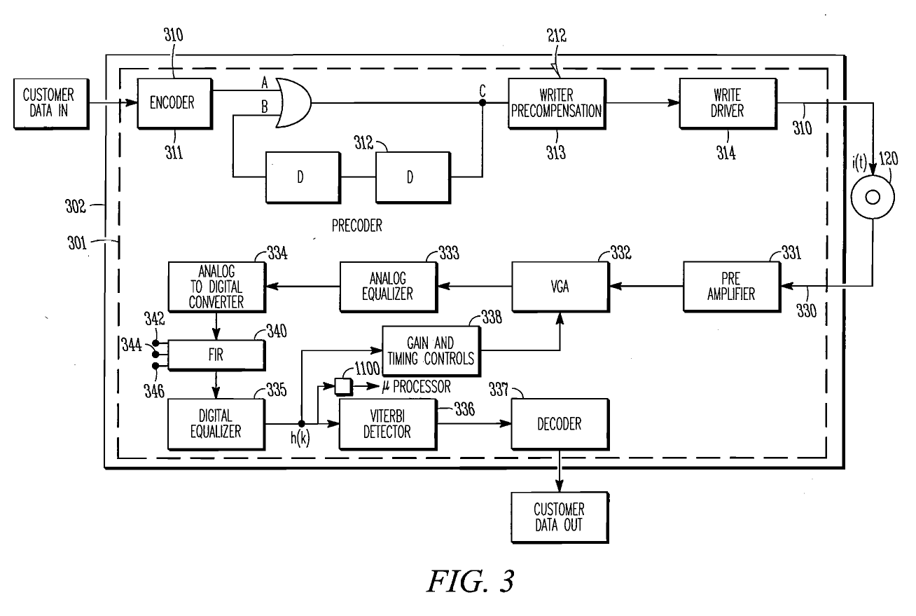

FIG. 3 is a schematic diagram of a read/write path 300 of the disk drive 100, according to an example embodiment. The read/write path 300 includes a write channel portion 310 and a read channel portion 330. The read/write path 300 is typically housed on a semiconductor chip, as depicted by the dotted line 301. The semiconductor chip is also placed on a printed circuit board 302, which is in turn attached to the housing 104 of the disk drive 100 (see FIG. 1). This is shown schematically in FIG. 3 so the size of the chip or semiconductor chip 301 relative to the printed circuit board 302 is out of scale. The read/write path 300 is typically contained in a semiconductor chip called a encoder/decoder (ENDEC). The read/write path 300 includes the write portion 310, which includes an encoder 311 and a precoder 312 for encoding the customer data, a write precompensation module 313, and a write driver 314. The write precompensation module 313 adjusts the signals associated with the encoded data so that, as written on the disk 120, the data will be more easily read using the read channel portion 330. The write driver 314 determines where the data will be written. In this particular embodiment, the data can either be written to a flush cache memory location 420 or to the disk 120 of the disk drive 100 (see FIG. 1). As will be discussed and described below, the flush cache memory location 420 can either be remote from the disk 120 or can be on the disk 120. The flush cache memory location 420 (shown in FIG. 3) is a schematic representation of the flush cache memory location and can include writing data to the disk 120 or to a memory location remote from the disk 120.

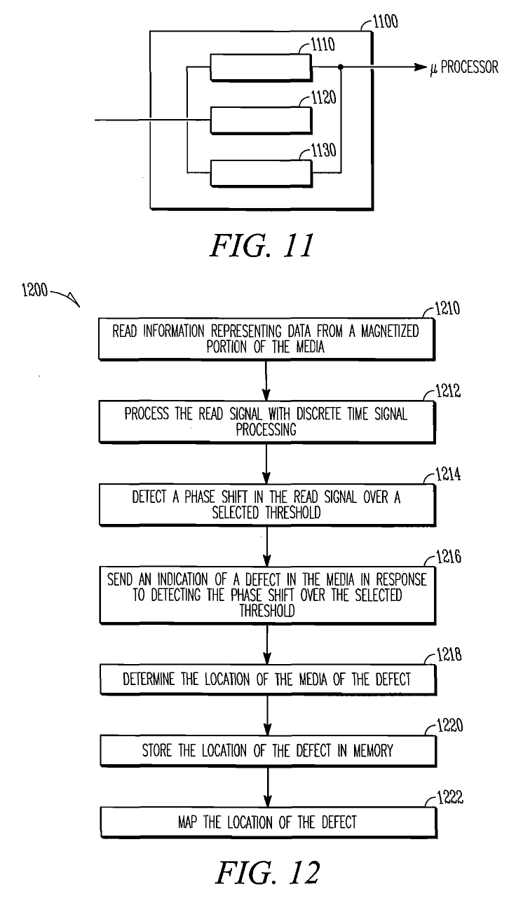

The read channel portion 330 of the read/write path includes a preamplifier 331, a variable gain amplifier 332, an analog equalizer 333, and an analog to digital converter 334. The elements 331 to 334 are used to amplify an analog signal, equalize it and convert it to a digital signal. After being converted by the analog to digital converter 334, the signal is then filtered by a finite impulse response (FIR) filter 340, and fed into a digital equalizer 335. Thereafter, the signal is then fed into a viterbi detector 336, and finally decoded by a decoder 337. The signal from the digital equalizer 335 is also fed to gain and timing controls 338, which are part of a feedback control loop to the variable gain amplifier 332. The signal from the digital equalizer 335 is also fed to a defect detector 1100 which detects defects during self-test or burn-in of the disk drive 100 (see FIG. 1). When a defect is detected, the defect detector 1100 outputs a signal to a microprocessor, such as microprocessor 210 shown in FIG. 2. The defect detector 1100 will be further detailed with respect to FIG. 11.

The FIR filter 340 includes various taps 342, 344, 346 that can be used to shape the signal from the digital equalizer or used to attenuate or substantially attenuate unwanted portions of a signal or attenuate an unwanted signal. It should be noted that FIG. 3 is one representative example of a read/write path 300. The invention is equally applicable to disk drive systems or magnetic recording systems that write transitions in the vertical orientation or write transitions in the horizontal orientation with respect to a major surface of the magnetic media, such as the disk of the disk drive.

In manufacturing a disk drive, various parameters for the disk drive are determined. In one example embodiment, some of the disk drive parameters are selected on an optimized basis. Conducting a test to detect errors on the disk and to map them generally includes two steps. The first step is to stress at least one of the various parameters for the disk drive. The second step is to scan the disk after stressing the at least one parameter. Two disk drive parameters that are stressed in conducting the test to identify and map disk defects include the write current and the track width.

The first disk drive parameter to be discussed is the write current. FIG. 4 is an flow diagram of a method 400 for selecting a write current for a magnetic media, according to an example embodiment. The method 400 for selecting a write current for a magnetic media includes writing a test track on a magnetic media at one of a plurality of write current levels 410, and writing signals to the magnetic media at positions adjacent to the test track at substantially the same write current level as used on the test track 412. The method 400 also includes reading the signals from the magnetic media at positions adjacent to the test track 414, and monitoring a parameter associated with the signals read from the adjacent test track 416. The method 400 also includes repeating the writing, reading and monitoring while after writing to a test track at another one of the plurality of write current levels 418, and selecting one of the plurality of write current levels based on the parameter monitored for signals read from the adjacent track for each of the selected plurality of write currents 420. In one embodiment, the parameter associated with the signals read from positions adjacent the test track 414 is an error rate, and selecting one of the various write current levels 420 includes selecting the write current that produces a minimum error rate in the signals read from the adjacent the test track. The error rate is detected with an error correction code associated with a read channel of the disk drive. The various write current levels selected for writing a test track on a magnetic media 410 are write current levels that magnetically saturate the magnetic media. In one embodiment, writing to the test track 410 and writing the signals to the disk at positions adjacent to the test track 412 includes writing transitions vertically with respect to a major surface of the media. In another embodiment, the transitions written horizontally with respect to a major surface of the media. In one embodiment, the write current level for writing to the test track 410 and the write current level for writing the signals to the disk at positions adjacent to the test track 412 are substantially the same. The magnetic media, in one embodiment, is a disk 120 of a disk drive 100 (see FIG. 1). It should be noted that this method 400, or any of the methods discussed herein, can be applied to any device that uses a magnetic media and is not limited to a disk drive. Other examples of devices that include a magnetic media include a magnetic tape drive or a floppy disk drive, or the like.

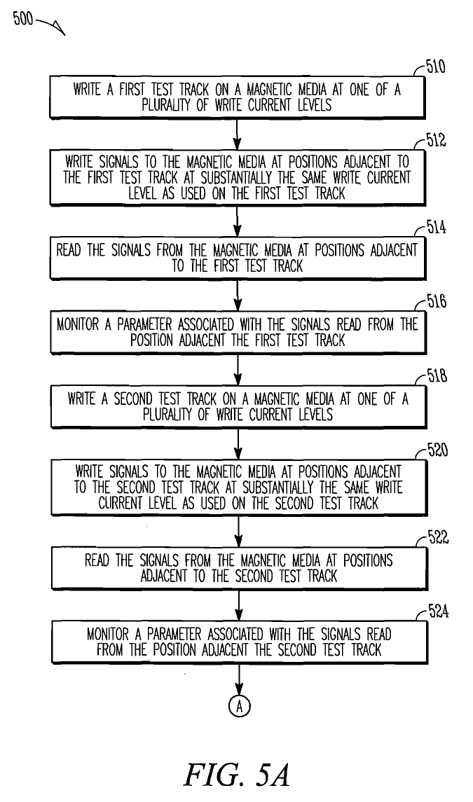

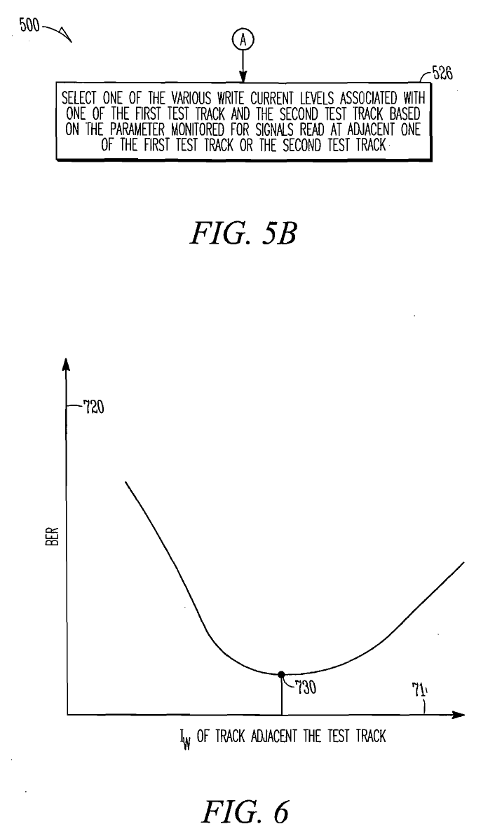

FIGS. 5A and 5B form FIG. 5. FIG. 5 is an flow diagram of a method 500 for selecting a write current for a magnetic medium, according to an example embodiment. The method 500 for selecting a write current for a magnetic storage device includes writing a first test track on a magnetic media at one of a plurality of write current levels 510, writing signals to the magnetic media at positions adjacent to the first test track at substantially the same write current level as used on the first test track 512, and reading the signals from the magnetic media at positions adjacent to the first test track 514. A parameter associated with the signals read from the position adjacent the first test track is monitored 516. The method 500 also includes writing a second test track on a magnetic media at one of a plurality of write current levels 518, writing signals to the magnetic media at positions adjacent to the second test track at substantially the same write current level as used on the second test track 520, and reading the signals from the magnetic media at positions adjacent to the second test track 522. A parameter associated with the signals read from the position adjacent the second test track is also monitored 524. One of the various write current levels associated with one of the first test track and the second test track is selected based on the parameter monitored for signals read at adjacent one of the first test track or the second test track 526. In one embodiment of the method 500, the first test track and the second test track are substantially the same track on the media associated with the magnetic storage device. In another embodiment of the method 500, the first test track and the second test track are different tracks on the media associated with the magnetic storage device. In one embodiment, the write head writes transitions in a vertical orientation with respect to a major surface of the magnetic media.

Using the methods of FIGS. 4 and 5, and plotting the results, the write current associated with a disk drive 100 (see FIG. 1) can be plotted verses a parameter for the track or tracks adjacent the test track indicative of the quality of the read back signal. One such parameter is the number of read errors. FIG. 6 is a graph 700 for selecting an optimum write current level for a magnetic medium in a disk drive, according to an example embodiment. The graph 700 is a plot of the write current (I_{w}) verses the bit error rate (BER) associated with a read of a track adjacent to the test track. The write current (I_{w}) is on the x-axis 71, and the bit error rate (BER) associated with a read of a track adjacent to the test track is on the y-axis 720. The write current (I_{w}) increases along the x-axis 71. The write current (I_{w}) at lower levels may not saturate the magnetic media and therefore the BER may be higher at these lower levels. As the write current (I_{w}) is increased a level is reached where the media is saturated. After the media is saturated, there is a point where the BER associated with a track adjacent to the test track is at a minimum 730. Increasing the write current beyond the minimum point 730 results in an increase in the BER in the track adjacent to the test track. At write currents beyond the minimum point 730, the write current on the test track affects the BER associated with reads from the track adjacent the test track. In other words, at a write current above the minimum point 730, the write current produces a bubble that is beyond the track and affects the adjacent track. At these write current (I_{w}) levels, writes to the adjacent track will also affect the BER associated with the test track. Therefore, the write current (I_{w}) level that produces a minimum BER in the adjacent tracks is an optimum level that will produce the least amount of errors in the magnetic media, such as a magnetic disk of a disk drive. Of course, the to the write current (I_{w}) level that produces a minimum BER may vary from disk drive to disk drive. In some disk drives, the write current (I_{w}) level that produces a minimum BER may vary from surface to surface on a disk within a disk drive. The minimum BER is based on the interaction of the write head with the magnetic media associated with the surface onto which the write head produces transitions. Even if the write heads are “identical” or made in an identical process, each one may be somewhat different in their writing characteristics. In addition, “identical” media made with identical processes may also vary. Thus, there may be different write currents (I_{w}) associated with different write transducers or write heads within a device, such as a disk drive. Therefore, in some embodiments of the invention the method for producing determining a minimum may be determined for each disk surface in a disk drive. In some embodiments, the different write current levels for each write transducer and disk surface may be determined during a self test after the disk drive is manufactured. In some embodiments, the instructions associated with the methods for selecting a write current (I_{w}) are stored in the microprocessor 210 associated with the disk drive 100. The result is stored in memory associated with the disk drive. Memory is also used to store the instruction sets associated with the various methods, such as method 400, 500 and 700.

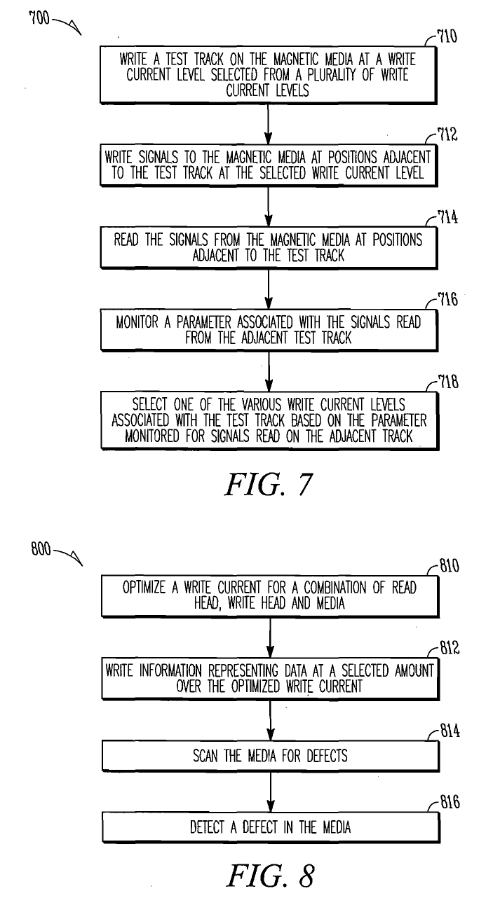

FIG. 7 is an flow diagram of yet another method 700 for selecting a write current for a magnetic media, according to an example embodiment. As mentioned above, a disk drive includes a write head, a read head, and a channel for reading and writing information from and to a magnetic media. The channel including an error detection and correction apparatus. The disk drive also includes a microcontroller for controlling portions of the disk drive. The microcontroller is capable of executing instructions that include the method 700 for selecting the write current for a magnetic media associated with the disk drive. More specifically, the microcontroller is capable of executing instructions that include writing a test track on the magnetic media at a write current level selected from a plurality of write current levels 710, writing signals to the magnetic media at positions adjacent to the test track at the selected write current level 712, reading the signals from the magnetic media at positions adjacent to the test track 714, and monitoring a parameter associated with the signals read from the adjacent test track 716. The microcontroller also executes instructions that select one of the various write current levels associated with the test track based on the parameter monitored for signals read on the adjacent track 718. The disk drive, in one example embodiment, monitors an error rate with the error detection and correction apparatus, and uses a memory for accumulating a number of errors or an error rate. The write head writes transitions in a vertical orientation with respect to a major surface of the magnetic media, and the read head reads transitions having the vertical orientation. In another embodiment, the write head writes transitions in a horizontal orientation with respect to a major surface of the magnetic media. The discussion set forth above discusses several methods for selecting a write current for a disk drive that is optimized or substantially optimized.

FIG. 8 is a flow diagram of a method 800 detailing one example embodiment of determining defects on a media by stressing the disk drive using the write current, according to an example embodiment. The method 800 of determining defects on a media of an information storage device includes optimizing a write current for a combination of read head, write head and media, as depicted by block 810, and writing information representing data at a selected amount over the optimized write current, as depicted by block 812. The method 800 also includes scanning the media for defects, as depicted by block 814. Writing the information representing data, 812 includes writing current at a selected percentage over the optimized write current. It is important to note that the method 800 includes optimizing or substantially optimizing the write current 810 in a particular drive. Each disk drive is different given that each of the components that make up the drive has a manufacturing tolerance. Components with different tolerances form the final disk drive. The result is that each disk drive is unique or different and also has a unique optimal write current for the given combination of components. In other words, part of the self-test during burn-in will include each drive determining the optimal write current for itself. Once the optimal write current is determined, a percentage may be applied to the determined optimal or substantially optimal write current as one stress condition applied to the drive. For example, the stress condition, in one example embodiment, may be to write tracks at 200% of the determined optimal or substantially optimal write current.

This prevents overstressing some of the manufactured drives that have a lower optimal or substantially optimal write current than other similarly manufactured disk drives. In the past, the write current was selected by determining a write current that saturated the media and then increasing it for good measure and to cover all variations in each of the disk drives manufactured with the “same” media and the “same” transducing head. No optimization takes place in such a scheme. In such an arrangement, the base write current for some drives may be well over an optimized level and increasing the write current by a selected percentage results in an extreme overstressing which causes many false errors. The method 800 further includes detecting a defect in the media.

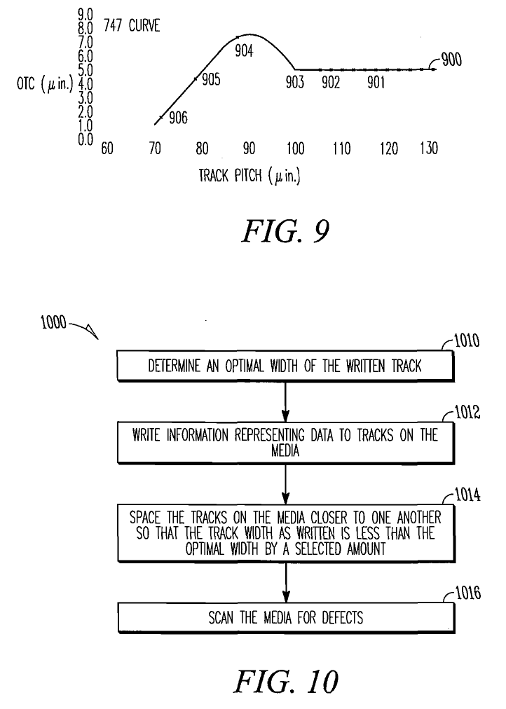

Another disk drive parameter to be discussed is the track width. This is also a function of the write head of the transducer used to read and write information from and to the disk. FIG. 9 is a representation of 747 curve 900 which is used in determining an optimal track width or an optimal distance between recording tracks, according to an example embodiment. The 747 curve 900 is a plot of track pitch verses off-track capability (OTC). The 747 curve 900 gets the name because the curve appears to look like the front portion of a 747 airplane. The 747 curve 900 is generated by writing a track and then filling the areas alongside the track of interest with noise, or old information. Next, signals are written on the track of interest over the old information. Each written track has a magnetic width and erase bands on each side. Then, adjacent tracks are written at a large track pitch, and engineers measure the OTC of the read head by moving the read element across the track of interest and measuring the bit error rate (BER) at the track pitch at point 901 in the graph. The 747 curve 900 or graph of FIG. 9 plots the distance that a head can move from a track's center (the vertical axis) as a function of track pitch while maintaining an acceptable BER. This process is repeated. For example, adjacent tracks are written again at a smaller track pitch and OTC is measured again at point 902. The process is repeated as the distance between adjacent tracks is reduced.

As track pitch decreases, the erase bands in the track of interest and those belonging to the adjacent tracks begin to interact, working together to erase the old information. The read-head “sees” the noise up to point 903 on the graph. The track signals work together, effectively decreasing noise and improving error rate and therefore OTC, which accounts for the hump in the curve at point 904. Here, the peak of the hump (corresponding to point 904) is where the two erase bands meet before they overlap. The old information has been completely overwritten. At this point, the head can deviate to its maximum distance (8 microinches in FIG. 9) from the center of the track while still maintaining an acceptable BER.

As track pitch continues to decrease, the OTC distance will return to the level where the old information was dominating the read signal (point 905). Point 905 is known as the average track spacing (ATS) point. Here, track spacing is equal to the width of the write head plus 1 erase band. At point 906, OTC all but vanishes because adjacent tracks are written too close to each other, or they encroach upon the track of interest, which increases BER.

The optimal track width or substantially optimal track width is associated with the track pitch at point 904. Given the determination of the optimal track width or substantially optimal track width, it can be used in a method 1000 described below.

FIG. 10 is a flow diagram of a method 1000 detailing one example embodiment of determining defects on a media by stressing the disk drive by writing the tracks having less than an optimal or substantially optimal width, according to an example embodiment. The method 1000 of determining defects on a media of an information storage device includes determining an optimal width of the written track 1010, writing information representing data to tracks on the media, the spacing between the tracks on the media being closer to one another so that the track width as written is less than the optimal width by a selected amount, and scanning the media for defects 1012. In some example embodiments, writing the information representing data to tracks 1012 results in tracks having a track width that is a selected percentage less the optimized width. In other words, the tracks are squeezed by a selected percentage to stress the drive and induce defects on a subsequent scan or reading of the tracks where the read back signals. The method 1000 also includes detecting a defect in the media 1014.

FIG. 11 is an apparatus 1100 for detecting defects, according to an example embodiment. The signal from the digital equalizer 335 (see FIG. 3) is fed to a defect detector 1100 which detects defects during self-test or burn-in of the disk drive 100 (see FIG. 1). When a defect is detected, the defect detector 1100 outputs a signal to a microprocessor, such as microprocessor 210 shown in FIG. 2. The defect detector 1100 shown in FIG. 11 includes a phase shift detector 1110, a frequency change detector 1120 and an amplitude detector 1130. The phase shift detector 1110 monitors the phase of the read signal. The phase shift detector 1110 also includes a selectable threshold. When the phase shift of the signal shifts phase by more than the selected threshold a signal 1112 is output to a microprocessor, such as microprocessor 210 (see FIG. 2). The microprocessor can then determine the location of the detected defect and store the location of the defect in memory so that the location of the defect is avoided when writing to the disk in response to subsequent write commands. The frequency change detector 1120 also includes a selectable threshold. When the frequency change of the read signal changes by more than the selected threshold, a signal 1122 is output to a microprocessor. Similarly, the amplitude detector 1130 also includes a selectable threshold. When the amplitude of the read signal changes by more than the selected threshold, a signal 1132 is output to a microprocessor. In each instance, the microprocessor determines the location of the detected defect and stores the location of the defect in memory so that the location of the defect is avoided when writing to the disk in response to subsequent write commands. It should be noted that the defect detector 1100 can be implemented with a single detector or with multiple detectors. In other words, for certain disk drives, a defect detector could have one or more detectors 1110, 1120, 1130 disabled. The detector works with either a disk that is perpendicularly recorded as well as with one that has transitions recorded horizontally on the surface. The detector also works with read signals that have been or will be digitized in the read channel.

FIG. 12 is a flow diagram of a method 1200 that details the determination of defects on a media, according to an example embodiment. The method 1200 of determining defects on a media of an information storage device includes reading information representing data from a magnetized portion of the media 1210, processing the read signal with discrete time signal processing 1212, and detecting a phase shift in the read signal over a selected threshold 1214. The method 1200 also includes sending an indication of a defect in the media in response to detecting the phase shift over the selected threshold 1216, and determining the location of the media of the defect 1218, and storing the location of the defect in memory 1220. In some embodiments, the method also includes mapping the location of the defect 1222. In some embodiments, the method includes processing the read signal with discrete time signal processing using partial response maximum likelihood signal processing. In other embodiments, the media is a magnetic media of a disk of a disk drive. This method 1200 can be used in a disk drives that records vertically or horizontally. In some embodiments, the method can also include detecting frequency or detecting amplitude over certain thresholds.

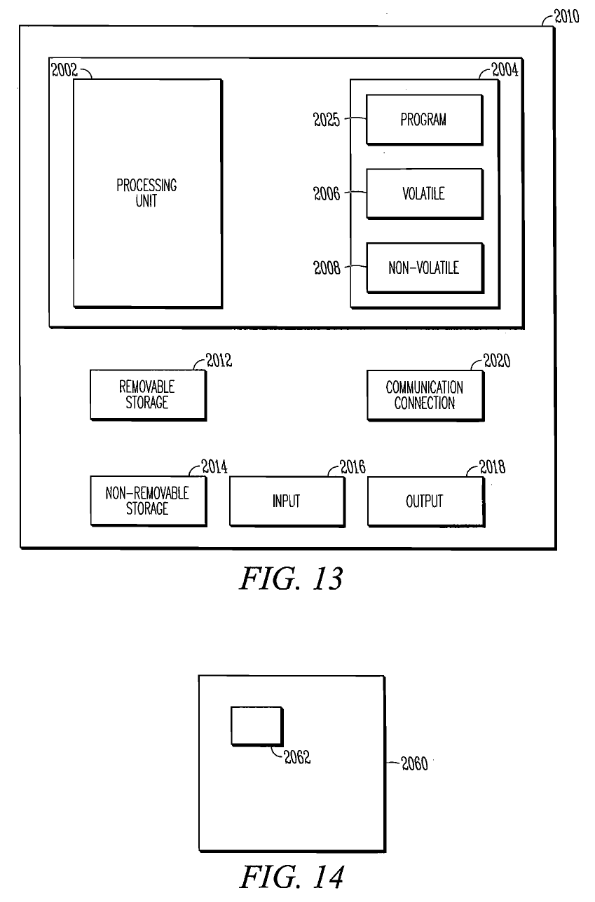

A block diagram of a computer system that executes programming for performing the above algorithm is shown in FIG. 13. A general computing device in the form of a computer 2010, may include a processing unit 2002, memory 2004, removable storage 2012, and non-removable storage 2014. Memory 2004 may include volatile memory 2006 and non volatile memory 2008. Computer 2010 may include any type of information handling system in any type of computing environment that includes any type of computer-readable media, such as volatile memory 2006 and non volatile memory 2008, removable storage 2012 and non-removable storage 2014. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 2010 may include or have access to a computing environment that includes input 2016, output 2018, and a communication connection 2020. The computer may operate in a networked environment using a communication connection to connect to one or more remote computers. The remote computer may include a personal computer (PC), server, router, network PC, a peer device or other common network node, or the like. The communication connection may include a Local Area Network (LAN), a Wide Area Network (WAN) or other networks. A microprocessor or controller associated with the disk drive 100 (see FIG. 1) is also such a computer system.

Computer-readable instructions stored on a machine-readable medium are executable by the processing unit 2002 of the computer 2010. A hard drive, CD-ROM, and RAM are some examples of articles including a machine-readable medium. For example, a computer program 2025 executed to control the writing of information associated with successive flush cache commands from a host 440 according to the teachings of the present invention may be included on a CD-ROM and loaded from the CD-ROM to a hard drive. The computer program may also be termed firmware associated with the disk drive 100. In some embodiments, a copy of the computer program 2025 can also be stored on the disk 120 of the disk drive 100.

FIG. 13 is a schematic diagram that shows a machine readable medium 2060 and an instruction set 2062 associated with the machine readable medium 2060, according to an example embodiment. The machine-readable medium 2060 provides instructions 2062 that, when executed by a machine, such as a computer, cause the machine to perform operations including reading information representing data from a magnetized portion of the media, processing the read signal with discrete time signal processing, and detecting a phase shift in the read signal over a selected threshold. In some embodiments, the machine-readable medium also provides instructions that cause the machine to perform operations that include sending an indication of a defect in the media in response to detecting the phase shift over the selected threshold, and determining the location of the media of the defect. In some embodiments, the machine-readable medium of provides instructions that, when executed by a machine, further cause the machine to detect a change in frequency in the read back signal. The machine-readable medium 2060 can also provide instructions 2062 that, when executed by a machine, such as a computer, cause the machine to perform operations including optimizing a write current for a combination of read head, write head and media, writing information representing data at a selected amount over the optimized write current, scanning the media for defects. The machine-readable medium 2060 can also provide instructions 2062 that, when executed by a machine, such as a computer, cause the machine to perform operations including determining an optimal width of the written track, writing information representing data to tracks on the media, the spacing between the tracks on the media being closer to one another so that the track width as written is less than the optimal width by a selected amount, and scanning the media for defects.

It should be noted that the computer, microcontroller, controller or the like can be internal to the information handling device or external to the information handling device. Furthermore, the computer, microcontroller, controller or the like can be part of a channel chip. In one embodiment, the computer, microcontroller, controller is internal or on board a disk drive information handling system. This enables the disk drive information handling system to execute the instruction sets using the onboard computer, at any time. One such time is during the manufacture of the disk drive, such as when a disk drive is undergoing the self test.

The foregoing description of the specific embodiments reveals the general nature of the invention sufficiently that others can, by applying current knowledge, readily modify and/or adapt it for various applications without departing from the generic concept, and therefore such adaptations and modifications are intended to be comprehended within the meaning and range of equivalents of the disclosed embodiments.

It is to be understood that the phraseology or terminology employed herein is for the purpose of description and not of limitation. Accordingly, the invention is intended to embrace all such alternatives, modifications, equivalents and variations as fall within the spirit and broad scope of the appended claims.

What is claimed is:

1. A method of determining defects on a media of an information storage device comprising:
reading information representing data from a magnetized portion of the media;
processing the read signal with discrete time signal processing; and
detecting a phase shift in the read signal over a selected threshold.

2. The method of claim 1 further comprising sending an indication of a defect in the media in response to detecting the phase shift over the selected threshold.

3. The method of claim 2 further comprising determining the location of the media of the defect.

4. The method of claim 3 further comprising storing the location of the defect in memory.

5. The method of claim 3 further comprising mapping the location of the defect.

6. The method of claim 1 wherein processing the read signal with discrete time signal processing includes partial response maximum likelihood signal processing.

7. The method of claim 1 wherein the magnetic media is a disk of a disk drive.

8. A method of determining defects on a media of an information storage device comprising:
optimizing a write current for a combination of read head, write head and media;
writing information representing data at a selected amount over the optimized write current; and
scanning the media for defects.

9. The method of claim 8 wherein writing the information representing data includes writing current at a selected percentage over the optimized write current.

10. The method of claim 8 further comprising detecting a defect in the media.

11. The method of claim 10 wherein detecting the defect includes detecting a phase shift in the read back signal.

12. The method of claim 10 wherein detecting the defect includes detecting a frequency change in the read back signal.

13. The method of claim 10 wherein detecting the defect includes detecting a amplitude change in the read back signal.

14. A method of determining defects on a media of an information storage device comprising:
determining an optimal width of the written track;
writing information representing data to tracks on the media, the spacing between the tracks on the media being closer to one another so that the track width as written is less than the optimal width by a selected amount; and
scanning the media for defects.

15. The method of claim 14 wherein writing the information representing data to tracks results in tracks having a track width that is a selected percentage less the optimized width.

16. The method of claim 14 further comprising detecting a defect in the media.

17. The method of claim 16 wherein detecting the defect includes detecting a phase shift in the read back signal.

18. The method of claim 16 wherein detecting the defect includes detecting a frequency change in the read back signal.

19. The method of claim 16 wherein detecting the defect includes detecting a amplitude change in the read back signal.

20. A channel apparatus for writing data to and reading data from a magnetic media, the channel apparatus comprising:
a write channel; and
a read channel, the read channel further comprising:
a phase shift detector for detecting a phase shift in the read back signal;
a phase shift threshold detector communicatively coupled to the phase shift detector, the phase shift threshold detector outputs a signal in response to a phase shift over a selected threshold.

21. The channel apparatus of claim 20 wherein the read channel further comprises an defect detection module, the output of the phase shift threshold detector input to the defect detection module, the defect detection module also determining the location of the defect.

22. The channel apparatus of claim 21 wherein the read channel further comprises:
a frequency change detector for detecting a frequency change in the read back signal;
a frequency change threshold detector communicatively coupled to the frequency change detector, the frequency change threshold detector outputs a signal in response to a frequency change over a selected threshold to the defect detection module.

23. The channel apparatus of claim 20 wherein the read channel further comprises:
a frequency change detector for detecting a frequency change in the read back signal;
a frequency change threshold detector communicatively coupled to the frequency change detector, the frequency change threshold detector outputs a signal in response to a frequency change over a selected threshold.

24. The channel apparatus of claim 20 wherein the channel apparatus is in a semiconductor chip.

25. A machine-readable medium that provides instructions that, when executed by a machine, cause the machine to perform operations comprising:
reading information representing data from a magnetized portion of the media;
processing the read signal with discrete time signal processing; and
detecting a phase shift in the read signal over a selected threshold.

26. The machine-readable medium of claim 25 that provides instructions that, when executed by a machine, further cause the machine to perform operations that further comprise sending an indication of a defect in the media in response to detecting the phase shift over the selected threshold.

27. The machine-readable medium of claim 26 that provides instructions that, when executed by a machine, further cause the machine to perform operations that further comprise determining the location of the media of the defect.

28. The machine-readable medium of claim 25 that provides instructions that, when executed by a machine, further cause the machine to perform operations that further comprise detecting a change in frequency in the read back signal.
